(19) United States
(12) Patent Application Publication
(10) Pub. No.: US 2013/0146683 A1
(43) Pub. Date: Jun. 13, 2013

(54) ELECTROSTATIC ATOMIZING DEVICE

(71) Applicants: Takeshi Imai, Osaka (JP); Kentaro Kobayashi, Hyogo (JP); Takayuki Nakada, Shiga (JP); Takafumi Omori, Shiga (JP); Yusuke Yamada, Shiga (JP)

(72) Inventors: Takeshi Imai, Osaka (JP); Kentaro Kobayashi, Hyogo (JP); Takayuki Nakada, Shiga (JP); Takafumi Omori, Shiga (JP); Yusuke Yamada, Shiga (JP)

(73) Assignee: PANASONIC CORPORATION, Osaka (JP)

(21) Appl. No.: 13/817,981

(22) PCT Filed: Sep. 22, 2011
(86) PCT No.: PCT/JP2011/071652

§ 371 Date: Feb. 20, 2013

(30) Foreign Application Priority Data
Sep. 27, 2010 (JP) 2010-215175

(51) Int. Cl. B05B 5/00

(52) U.S. Cl. CPC B05B 5/001
USPC 239/690

(57) ABSTRACT

The atomizing electrode of the electrostatic atomizing device has a discharging part and a base. A portion of the atomizing electrode between the discharging part and the base is a large diameter part with a diameter larger than the base. The large diameter part separates condensed water retained near the base from condensed water retained on the discharging part.

### TECHNICAL FIELD

The present invention relates to an electrostatic atomizing device that generates charged fine water particles.

### BACKGROUND ART

Patent document 1 describes an example of an electrostatic atomizing device that cools an atomizing electrode (discharge electrode in patent document 1) to generate condensed water on the electrode. The condensed water held on the atomizing electrode is then atomized by the atomizing electrode to generate charged fine water particles, which are mildly acidic and include electric charges. The charged fine water particles function to moisturize skin and hair and function to deodorize air and articles. Thus, many effects may be obtained by using the electrostatic atomizing device in various products.

In the electrostatic atomizing device of patent document 1, a cooling unit such as a Peltier module is used to cool the atomizing electrode and generate condensed water on the surface of the atomizing electrode.

### PRIOR ART DOCUMENTS

### Patent Document

Patent Document 1: Japanese Laid-Open Patent Publication

### SUMMARY OF THE INVENTION

### Problems that are to be Solved by the Invention

In an electrostatic atomizing device such as that described above, when the cooling unit cools the atomizing electrode, the atomizing electrode may entirely be covered with condensed water. When the atomizing electrode is entirely covered with condensed water, discharging becomes instable at a discharge portion that is located at a distal end of the atomizing electrode. This may lead to instable generation of charged fine water particles.

It is an object of the present invention to provide an electrostatic atomizing device that generates charged fine water particles in a further preferable manner.

### Means for Solving the Problem

An electrostatic atomizing device according to one aspect of the present invention generates charged fine water particles by cooling an atomizing electrode with a cooling unit to generate condensed water on a surface of the atomizing electrode and applying voltage to the condensed water held on a discharge portion, which is a distal end of the atomizing electrode. The electrostatic atomizing device is characterized in that the atomizing electrode includes a large diameter portion between the discharge portion and a base, which is located at a basal end of the atomizing electrode, and the large diameter portion has a larger diameter than the base.

Preferably, the base of the atomizing electrode is connected via a support, which supports the atomizing electrode, to the cooling unit in a manner allowing for heat transmission, and the large diameter portion has a larger diameter than the support.

In one example, the discharge portion of the atomizing electrode is shaped so that its diameter gradually increases from a distal end to a basal end of the discharge portion. Further, the large diameter portion has the same diameter as the basal end of the discharge portion, and the large diameter portion is formed to be continuous from a basal end of the large diameter portion to a distal end of the base.

In one example, the atomizing electrode includes a spherical or generally spherical head, and the head includes an upper semispherical portion, which serves as the discharge portion, and a lower semispherical portion. The large diameter portion is a portion on the head corresponding to a boundary of the upper semispherical portion and the lower semispherical portion.

In one example, the atomizing electrode includes a head, and the head includes an upper semispherical portion, which serves as the discharge portion, and a cylindrical portion, which has the same diameter as the upper semispherical portion. The large diameter portion is the cylindrical portion of the head.

In one example, the atomizing electrode further includes a shaft that connects the head and the base, and the shaft has a diameter that is smaller than that of the large diameter portion to form a step in at least a portion connecting the shaft and the base.

In one example, the head is directly connected to the base, and a step is formed at a portion connecting the head and the base.

In one example, the atomizing electrode is an elongated metal member extending from the head to the base. The large diameter portion is a portion corresponding to the largest dimension of the atomizing electrode in a horizontal cross-sectional plane perpendicular to a longitudinal axis of the atomizing electrode.

### Effect of the Invention

The present invention provides an electrostatic atomizing device that generates charged fine water particles in a further preferable manner.

### BRIEF DESCRIPTION OF THE DRAWINGS

FIG. 1 is a schematic diagram illustrating one embodiment of an electrostatic atomizing device;

FIG. 2A is a schematic diagram illustrating condensed water held on the atomizing electrode in a state in which the supplied amount is sufficient;

FIG. 2B is a schematic diagram illustrating condensed water held on the atomizing electrode in a state in which the supplied amount is excessive; and

FIG. 3 is a schematic diagram illustrating a further example of an atomizing electrode.

### EMBODIMENTS OF THE INVENTION

An electrostatic atomizing device according to one embodiment of the present invention will now be described with reference to the drawings.

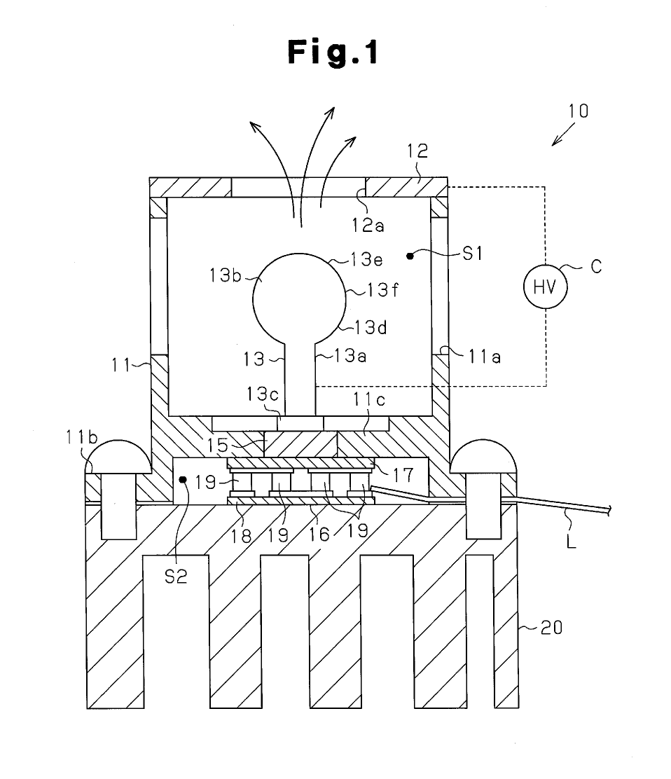

As illustrated in FIG. 1, an electrostatic atomizing device 10 of the present invention includes a support frame 11 formed by an insulative resin material, such as PBT resin, polycarbonate resin, or PPS resin. The support frame 11 includes, for example, a hollow portion 11a and an annular fastening flange 11b, which are formed integrally. The hollow portion 11a is generally cylindrical, and the fastening flange 11b extends outward from the basal portion (bottom portion as viewed in FIG. 1) of the hollow portion 11a. The hollow portion 11a includes an inner surface formed integrally with a partition wall 11c that divides the internal space of the support frame 11 into an atomizing void S1 and a sealed void S2. The hollow portion 11a has a distal surface (top surface as viewed in FIG. 1) on which a ring-shaped opposing electrode 12 is arranged. The opposing electrode 12 includes a central opening that defines a mist outlet 12a.

A conductive metal atomizing electrode 13 is arranged in the hollow portion 11a. The atomizing electrode 13 includes a main electrode body 13a, which extends in the axial direction of the hollow portion 11a, a head 13b, which is formed at a distal end of the main electrode body 13a, and a base 13c, which is formed at a basal end of the main electrode body 13a. In a preferred example, the main electrode body 13a is cylindrical or generally cylindrical, the head 13b is spherical or generally spherical, and the base 13c is disk-shaped. In the present specification, the main electrode body 13a may be referred to as a shaft that connects the head 13b and the base 13c. The head 13b includes a lower semispherical portion 13d and an upper semispherical portion 13e. The lower semispherical portion 13d is generally semispherical, continuous with the main electrode body 13a, and increasing in diameter toward the distal end. The upper semispherical portion 13e is generally spherical, continuous with the lower semispherical portion 13d, and decreasing in diameter toward the distal end. The upper semispherical portion 13e is one example of a discharge portion.

The atomizing electrode 13 includes a large diameter portion 13f between the upper semispherical portion 13e, which serves as the discharge portion, and the base 13c, which is located at the basal end of the atomizing electrode 13. In the present embodiment, the large diameter portion 13f is a portion of the head 13b in the atomizing electrode 13. For example, the large diameter portion 13f is formed at a boundary between the upper semispherical portion 13e and the lower semispherical portion 13d.

The atomizing electrode 13 is arranged in the hollow portion 11a hollow portion 11a so that at least its distal portion, namely, the upper semispherical portion 13e is arranged in the atomizing void S1. The arrangement of the atomizing electrode 13 provides a clearance from the opposing electrode 12. Further, the atomizing electrode 13 is connected to a high voltage power circuit C, which applies high voltage.

The sealed void S2 accommodates a cooling insulative plate 15, which contacts the basal surface (lower surface as viewed in FIG. 1) at the base 13c of the atomizing electrode 13. The cooling insulative plate 15 is formed from a material that provides high thermal conductivity and excellent electricity resistance, such as alumina or aluminum nitride. In the illustrated embodiment, the cooling insulative plate 15 functions as a support that supports the base 13c. The cooling insulative plate 15 has a diameter that is larger than the base 13c and smaller than the large diameter portion 13f.

A Peltier module 16 is arranged in the sealed void S2. The Peltier module 16 is connected via the cooling insulative plate 15 to the atomizing electrode 13 (specifically, the base 13c) in a manner allowing for heat transmission. The Peltier module 16 is formed by arranging a plurality of Bi—Te thermoelectric elements 19 between two circuit substrates 17 and 18. The circuit substrates 17 and 18 are printed circuit boards of insulative plates having high thermal conductivity (e.g., alumina and aluminum nitride). Circuits are formed on opposing surfaces of the circuit substrates 17 and 18. The circuits electrically connect the thermoelectric elements 19. Further, the thermoelectric elements 19 are connected via a Peltier input lead line L to a control unit (not illustrated). The control unit controls the activation of the thermoelectric elements 19 through the Peltier input lead line L. When the thermoelectric elements 19 are supplied with power through the Peltier input lead line L, heat is transferred from one circuit substrate 17, which is in contact with the cooling insulative plate 15, toward the other circuit substrate 18.

A heat radiation unit 20 (e.g., heat radiation fins) are connected to the rear surface (surface that does not include an electric circuit) of the circuit substrate 18. The heat radiation unit 20 is fastened by screws to the flange 11b of the support frame 11. Further, the heat radiation unit 20 is formed to have a larger surface area than the surface area of the circuit substrate 18 to effectively radiate heat from the circuit substrate 18.

In the electrostatic atomizing device 10, power is supplied from a power supply (not illustrated) through the input lead line L to the Peltier module 16 to heat one surface (upper surface in FIG. 1) of the Peltier module 16. The Peltier module 16 cools the atomizing electrode 13. Moisture in the air condenses on the surface of the cooled atomizing electrode 13 and provides water (condensed water) to the atomizing electrode 13.

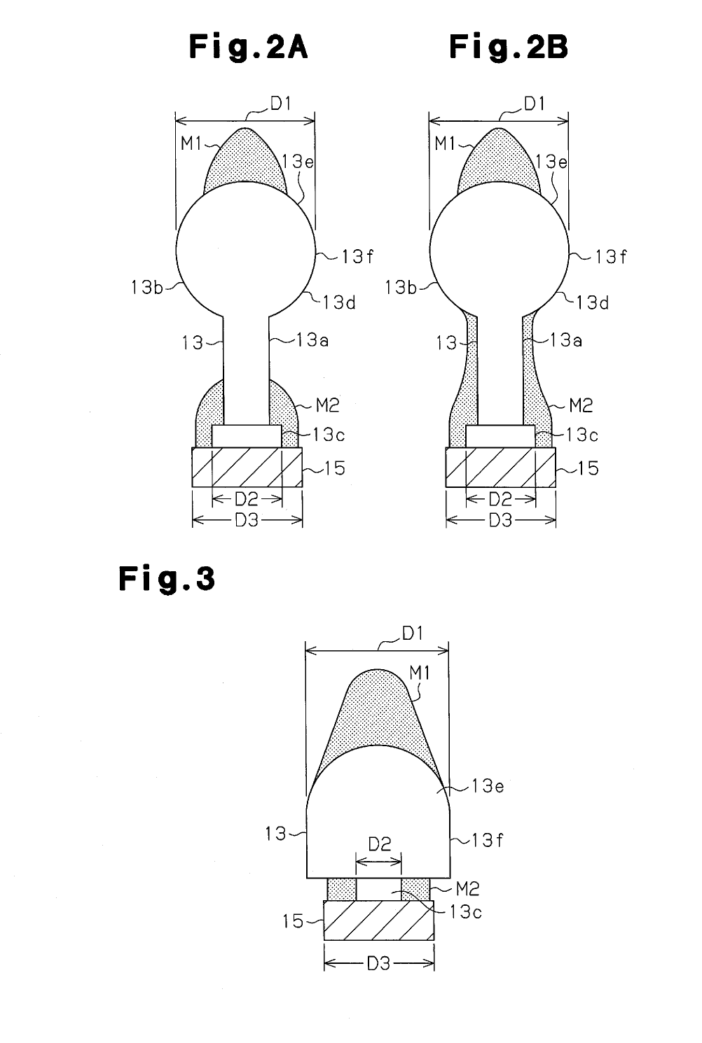

In a state in which condensed water M1 (refer to FIGS. 2A and 2B) is provided to or held on the upper semispherical portion 13e of the atomizing electrode 13, the high voltage power circuit C applies high voltage to between the atomizing electrode 13 and the opposing electrode 12. This results in the condensed water M1 undergoing Rayleigh fission and electrostatic atomization thereby forming charged fine water particles of nanometer size including active species and serving as charged fine water particles. The generated charged fine water particles pass through the hollow portion 11a toward the mist outlet 12a and are discharged out of the hollow portion 11a.

As illustrated in FIGS. 2A and 2B, the large diameter portion 13f of the atomizing electrode 13 has a diameter D1 that is larger than a diameter D2 of the base 13c and a diameter D3 of the cooling insulative plate 15, which serves as the support connected to the rear surface of the base 13c. Thus, even when condensed water (also referred to as excessive condensed water) M2 accumulated on the base 13c of the atomizing electrode 13 and in the vicinity of the cooling insulative plate 15 gradually increases from a sufficient state illustrated in FIG. 2A to an excessive state illustrated in FIG. 2B, the large diameter portion 13f obstructs the excessive condensed water M2 so that the excessive condensed water M2 does not join the condensed water M1 on the upper semispherical portion 13e. This suppresses the effects of the excessive condensed water M2 on the discharge that occurs at the upper semispherical portion 13e when high voltage is applied between the electrodes 12 and 13. As a result, charged fine water particles can be stably generated.

To separate the excessive condensed water M2 from the condensed water M1, the arrangement of a partition plate or the like, which is discrete from the atomizing electrode 13, between the base 13c and the upper semispherical portion 13e would also be effective. However, the arrangement of a discrete partition plate would increase the number of components and the number of coupling steps. In contrast, the atomizing electrode 13 of the present embodiment includes the large diameter portion 13f, which keeps the excessive condensed water M2 separated from the condensed water M1. Thus, the present embodiment decreases the number of components and the number of coupling steps compared to a structure that uses a partition plate.

The advantages of the present embodiment will now be described.

(1) The atomizing electrode 13 includes the large diameter portion 13f, which has a larger diameter than the base 13c, between the upper semispherical portion 13e, which serves as a discharge portion, and the base 13c, which is the basal end of the atomizing electrode 13. The large diameter portion 13f keeps the condensed water M1, which is on the upper semispherical portion 13e, separated from the excessive condensed water M2, which is in the vicinity of the base 13c. This stabilizes discharging of the upper semispherical portion 13e in a further preferable manner and further stably generates charged fine particles.

(2) The base 13c of the atomizing electrode 13 serves as the support that supports the atomizing electrode 13 in a manner allowing for heat transmission to the Peltier module 16, which serves as a cooling unit, through the cooling insulative plate 15. Further, the large diameter portion 13f of the atomizing electrode 13 has a larger diameter than the cooling insulative plate 15. This keeps the excessive condensed water M2 accumulated on the upper surfaces of the base 13c and the cooling insulative plate 15 separated from the condensed water M1 on the upper semispherical portion 13e. As a result, discharging at the upper semispherical portion 13e is stabilized in a preferable manner and ensures that charged fine particles are generated with further stability.

(3) The head 13b of the atomizing electrode 13 is spherical or generally spherical, and the large diameter portion 13f corresponds to the boundary between the upper semispherical portion 13e and the lower semispherical portion 13d. In this case, the surface area of the upper semispherical portion 13e serving as the discharge portion can be increased. Accordingly, while increasing the amount of the condensed water M1 held on the upper semispherical portion 13e, the large diameter portion 13f separates the condensed water M1 from the excessive condensed water M2. This allows for stable generation of a vast amount of charged fine particles.

(4) Further, the diameter of the main electrode body 13a, or shaft, connecting the head 13b and the base 13c is smaller than the diameter of the large diameter portion 13f. In this structure, a step functioning as a liquid reservoir that holds the excessive condensed water M2 is formed below the large diameter portion 13f in at least the portion connecting the main electrode body 13a and the base 13c (refer to FIG. 2A). Accordingly, while increasing the amount of the excessive condensed water M2 that can be held in the vicinity of the base 13c, the excessive condensed water M2 can be easily maintained in a state separated from the condensed water M1 held on the upper semispherical portion 13e. This allows for stable generation of electrostatic fine water particles.

(5) The opposing electrode 12 is arranged at a position opposing the atomizing electrode 13. Such arrangement of the opposing electrode 12 stabilizes discharging between the opposing electrode 12 and the atomizing electrode 13. This allows for stable generation of electrostatic fine water particles.

The embodiment of the present invention may be modified as described below.

In the above embodiment, the atomizing electrode 13 includes the main electrode body 13a that connects the head 13b (large diameter portion 13f) and the base 13c and has a smaller diameter than the large diameter portion 13f and the base 13c. However, the small diameter main electrode body 13a may be omitted. For instance, in the example illustrated in FIG. 3, the head of the atomizing electrode 13 includes an upper semispherical portion 13e and a large diameter portion 13f, which is a cylindrical portion having generally the same diameter as the upper semispherical portion 13e. A base 13c is formed to be continuous with a basal end of the large diameter portion 13f (basal end of the head). Such a structure simplifies the shape of the atomizing electrode 13. Thus, the atomizing electrode 13 can be reduced in size (entire length can be shortened), and the cooling efficiency of the Peltier module 16 can be improved. Further, since the cooling efficiency of the Peltier module 16 can be improved, the Peltier module 16 can be reduced in size. In the example of FIG. 3, a step is formed at a portion connecting the head (in particular, the large diameter portion 13f) and the base 13c. The step functions as a liquid reservoir that holds the excessive condensed water M2 in the vicinity of the base 13c. The excessive condensed water M2 is separated from the condensed water M1. Thus, charge fine particles can be stably generated. Further, the upper semispherical portion 13e, which serves as the discharge portion, has the same diameter as the large diameter portion 13f. Thus, the amount of condensed water M1 held on the upper semispherical portion 13e can be increased, and a vast amount of charged fine particles can be stably generated.

In the above embodiment, the discharge portion is formed by the upper semispherical portion 13e, which includes a spherical surface and is arranged at the distal end of the atomizing electrode 13. However, the discharge portion may be conical and have an acute tip.

In the above embodiment, the diameter D1 of the large diameter portion 13f is larger than the diameter D2 of the base 13c and the diameter D3 of the cooling insulative plate 15, which serves as the support. However, there is no such limitation, and the large diameter portion 13f merely needs to have a larger diameter than the diameter D2 of the base 13c.

In the above embodiment, the base 13c of the atomizing electrode 13 is indirectly connected by the cooling insulative plate 15 to the Peltier module 16. However, for example, the cooling insulative plate 15 may be omitted. In this case, the base 13c of the atomizing electrode 13 is directly connected to the Peltier module 16.

In the above embodiment, high voltage is applied to between the atomizing electrode 13 and the opposing electrode 12, which is arranged opposing the atomizing electrode 13. However, for example, the opposing electrode 12 may be omitted, and high voltage may be applied to the atomizing electrode 13.

### DESCRIPTION OF THE REFERENCE CHARACTERS

10: electrostatic atomizing device, 13: atomizing electrode, 13c: base, 13e: upper semispherical portion serving as discharge portion, 13f: large diameter portion, 15: cooling insulative plate serving as support, M1: condensed water.

1. An electrostatic atomizing device that generates charged fine water particles by cooling an atomizing electrode with a cooling unit to generate condensed water on a surface of the atomizing electrode and applying voltage to the condensed water held on a discharge portion, which is a distal end of the atomizing electrode, the electrostatic atomizing device being characterized in that:
the atomizing electrode includes a large diameter portion between the discharge portion and a base, which is located at a basal end of the atomizing electrode, and the large diameter portion has a larger diameter than the base.

2. The electrostatic atomizing device according to claim 1, wherein the base of the atomizing electrode is connected via a support, which supports the atomizing electrode, to the cooling unit in a manner allowing for heat transmission, and the large diameter portion has a larger diameter than the support.

3. The electrostatic atomizing device according to claim 1, being characterized in that:
the discharge portion of the atomizing electrode is shaped so that its diameter gradually increases from a distal end to a basal end of the discharge portion; and
the large diameter portion has the same diameter as the basal end of the discharge portion, and the large diameter portion is formed to be continuous from a basal end of the large diameter portion to a distal end of the base.

4. The electrostatic atomizing device according to claim 1, being characterized in that:
the atomizing electrode includes a spherical or generally spherical head, and the head includes an upper semispherical portion, which serves as the discharge portion, and a lower semispherical portion; and
the large diameter portion is a portion on the head corresponding to a boundary of the upper semispherical portion and the lower semispherical portion.

5. The electrostatic atomizing device according to claim 1, being characterized in that:
the atomizing electrode includes a head, and the head includes an upper semispherical portion, which serves as the discharge portion, and a cylindrical portion, which has the same diameter as the upper semispherical portion; and
the large diameter portion is the cylindrical portion of the head.

6. The electrostatic atomizing device according to claim 4, being characterized in that:
the atomizing electrode further includes a shaft that connects the head and the base, and the shaft has a diameter that is smaller than that of the large diameter portion to form a step in at least a portion connecting the shaft and the base.

7. The electrostatic atomizing device according to claim 5, being characterized in that:
the head is directly connected to the base, and a step is formed at a portion connecting the head and the base.

8. The electrostatic atomizing device according to claim 1, being characterized in that:
the atomizing electrode is an elongated metal member extending from the head to the base; and
the large diameter portion is a portion corresponding to the largest dimension of the atomizing electrode in a horizontal cross-sectional plane perpendicular to a longitudinal axis of the atomizing electrode.
